(19) United States
(12) Patent Application Publication
(10) Pub. No.: US 2022/0194207 A1
(43) Pub. Date: Jun. 23, 2022

(54) Hybrid Transmission Assembly and Motor Vehicle

(71) Applicant: ZF Friedrichshafen AG, Friedrichshafen (DE)

(72) Inventors: Stefan Beck, Eriskirch (DE); Johannes Kaltenbach, Friedrichshafen (DE); Matthias Horn, Tettnang (DE); Michael Wechs, Weißensberg (DE); Thomas Martin, Weissensberg (DE); Martin Brehmer, Tettnang (DE); Fabian Kutter, Kressbronn (DE); Peter Ziemer, Tettnang (DE); Oliver Bayer, Hörbranz (AT); Thomas Kroh, Lindau (DE); Max Bachmann, Friedrichshafen (DE)

(21) Appl. No.: 17/602,958

(22) PCT Filed: Mar. 3, 2020
(86) PCT No.: PCT/EP2020/055533

§ 371 Date: Oct. 11, 2021

(30) Foreign Application Priority Data
Apr. 12, 2019 (DE) 10 2019 205 328.9

(51) Int. Cl. B60K 6/547; B60K 6/36; B60K 6/387; F16H 3/091; B60K 6/40; B60K 6/48

(52) U.S. Cl. CPC B60K 6/547; B60K 6/36; B60K 6/387; F16H 3/091; B60K 2006/4825; B60K 6/48; F16H 2200/0056; B60Y 2200/92; B60K 6/40

(57) ABSTRACT

A hybrid transmission device (3, 56, 60, 64) includes a first transmission input shaft (12) and a second transmission input shaft (14) mounted on the first transmission input shaft, at least one drive device (EM2), at least one clutch (K3) for the rotationally fixed connection of two shafts (12, 14), and at least one gearshift clutch for the rotationally fixed connection of an idler gear to a shaft (12, 14). The second transmission input shaft (14) has an end (20) facing the outer side of the hybrid transmission device (3) and an end (22) facing the inner side of the hybrid transmission device (3). In the axial direction, the connecting clutch (K3) is arranged at one end (20, 22) of the second transmission input shaft (14), and the gearshift clutch (B, E) is arranged at the other end (22, 20) of the second transmission input shaft (14).

### CROSS-REFERENCE TO RELATED APPLICATIONS

The present application is related and has right of priority to German Patent Application No. 102019205328.9 filed in the German Patent Office on Apr. 12, 2019 and is a nationalization of PCT/EP2020/055533 filed in the European Patent Office on Mar. 3, 2020, both of which are incorporated by reference in their entirety for all purposes.

### FIELD OF THE INVENTION

The invention relates generally to hybrid transmission devices.

### BACKGROUND

It is known to utilize hybrid transmission devices to reduce the carbon dioxide (CO2) emissions of motor vehicles. A hybrid transmission device is understood to be a transmission device, onto which an internal combustion engine and at least one further drive device are couplable. It is known to hybridize all automated transmissions, for example, automatic transmissions and dual clutch transmissions. DE10 2011 005 451 A1 describes a transmission that includes two electric motors and has five forward gears and one reverse gear.

### SUMMARY OF THE INVENTION

Example aspects of the present invention provide a hybrid transmission device that has a compact design for front-mounted transverse applications and offers the possibility to obtain multiple embodiments with a small number of components.

According to example aspects of the invention, a hybrid transmission device includes a first transmission input shaft, a second transmission input shaft mounted on the first transmission input shaft, at least one drive device, at least one connecting clutch for the rotationally fixed connection of two input shafts, and at least one gearshift clutch for the rotationally fixed connection of an idler gear to a shaft. The second transmission input shaft has an end facing the outer side of the hybrid transmission device and an end facing the inner side of the hybrid transmission device. The connecting clutch is arranged at one end of the second transmission input shaft, and the gearshift clutch is arranged at the other end of the second transmission input shaft, in the axial direction.

The gearshift clutch at one end of the second transmission input shaft can be offset in the radial direction and/or the circumferential direction with respect to the second transmission input shaft. However, the axial positioning is essential. Therefore, the position of the appropriate idler gear and fixed gear of the associated gear step has nevertheless also always been established, since the idler gear and the fixed gear are located laterally adjacent to the gearshift clutch in the axial direction.

The connecting clutch connects the first transmission input shaft to the second transmission input shaft and, therefore, cannot be offset with respect to the axis of the second transmission input shaft.

The transmission of the hybrid transmission device is advantageously designed as a gear change transmission. The transmission has at least two discrete gear steps in this case.

Advantageously, the gear change transmission can include at least two, in particular precisely two, sub-transmissions. This allows for increased functionality and, for example, tractive force support during a gear change, in particular an internal-combustion-engine gear change as well as an electric gear change.

Preferably, at least one of the sub-transmissions can be designed as a gear change transmission. In particular, two or more, in particular precisely two, sub-transmissions can be designed as gear change transmissions. The sub-transmissions then have at least two gear steps.

Advantageously, at least one of the sub-transmissions can have at least two gear steps. Preferably, all, in particular both, sub-transmissions can have at least two gear steps. Preferably, one sub-transmission can have precisely two gear steps and the second sub-transmission can have precisely three gear steps.

Advantageously, the gear change transmission includes gearwheels and shift elements. The gearwheels are preferably designed as spur gears.

Preferably, the transmission of the hybrid transmission device is designed as a stationary transmission. In stationary transmissions, the axes of all gearwheels in the transmission are fixed in relation to the transmission housing.

Preferably, the gear change transmission is designed as a transmission of a countershaft design. Preferably, the gear change transmission is designed as a spur gear drive. The gearwheels are designed as spur gears in this case.

In addition, the transmission can be designed as a dual clutch transmission. It has two transmission input shafts in this case.

In addition, the transmission preferably includes at least two transmission input shafts. Preferably, the transmission includes precisely two transmission input shafts. With three or more transmission input shafts, although a larger number of sub-transmissions can be produced, the described functionality can be achieved already with two transmission input shafts.

Preferably, the first transmission input shaft is designed as a solid shaft. Regardless of the design of the first transmission input shaft, the second input shaft is preferably mounted on the first transmission input shaft. Thus, the second transmission input shaft is arranged coaxially thereto and encloses the first transmission input shaft. The first transmission input shaft is a hollow shaft in this case.

Preferably, the hybrid transmission device can include at least one, in particular precisely one, countershaft. In the case that a single countershaft is utilized, a single point of connection to the differential is present. As a result, installation space can be saved, which is the case in the radial direction as well as in the axial direction.

Therefore, the transmission in one preferred example embodiment includes precisely three shafts, namely two transmission input shafts and one countershaft, which is also the output shaft in this case.

In an all-wheel variant of the transmission, one shaft is always added, which, as a power take-off, drives the second motor vehicle axle.

A gear step, as already described at the outset, is a mechanically implemented ratio between two shafts. The overall gear ratio between the internal combustion engine or the drive device and the wheel has further ratios, wherein the ratios upstream from a gear step, the pre-ratios, can depend on the input that is utilized. The post-ratios are usually identical. In an example embodiment shown further below, the rotational speed and the torque of a drive device are transmitted multiple times, namely by at least one gearwheel pair between the output shaft of the drive device and a transmission input shaft. This is a pre-ratio. This is followed by a gearwheel pair of a gear step with a ratio dependent on the gear step. Finally, this is followed by a gearwheel pair between the countershaft and the differential, as a post-ratio. A gear has an overall gear ratio that depends on the input and the gear step. Unless indicated otherwise, a gear relates to the utilized gear step.

Merely for the sake of clarity, it is pointed out that the ascending numbers of the gear steps refer, as usual, to a descending ratio. A first gear step G1 has a higher ratio than a second gear step G2, etc.

If torque originating from the internal combustion engine is transmitted via the first gear step G1, this is referred to as internal-combustion-engine gear V1. If the second drive device and the internal combustion engine simultaneously transmit torque via the first gear step G1, this is referred to as hybrid gear H11. If only the second drive device transmits torque via the first gear step G1, this is referred to as an electric gear E1.

Preferably, the transmission of the hybrid transmission device has at least three gear steps or gear stages. The gearwheels of a gear step can be arranged in a gear plane when the gear step includes two gear-step gears. Preferably, the transmission has at least four gear steps or gear stages. Preferably, the transmission has at least five, in particular precisely five, gear steps.

Preferably, the transmission of the hybrid transmission device has one more gear plane than gear steps. In the case of four gears, this is five gear planes. The gear plane for connecting the drive output, for example, a differential, is included in the count.

Preferably, all gear steps of one of the sub-transmissions can be utilized in an internal combustion engine-driven and electrical or fluidic manner. As a result, a maximum number of gears can be obtained at a low number of gear steps. In particular, exclusively one sub-transmission can be electrically or fluidically utilized. This is sufficient in order to obtain a hybrid operation; a further connection between the sub-transmissions or a second drive device increase, primarily, the necessary installation space.

Advantageously, the hybrid transmission device and/or the transmission can be designed to be free from a reversing gearwheel for reversing the direction. Therefore, the reverse gear is not produced via the internal combustion engine, but rather via the drive device or at least one of the drive devices. In this case, for example, the first gear step or the second gear step can be utilized.

Preferably, gear-step gearwheels for all even gear steps can be arranged on the first transmission input shaft. In addition, gear-step gears of all odd gear steps can be preferably arranged at the second transmission input shaft. Gear-step gears, which are also referred to as gear-step gearwheels, can be designed as fixed gears or idler gears. The gear-step gears are referred to as gear-step gears, because the gear-step gears are associated with a gear step.

Preferably, the highest even gear step and/or one of the gear-step gears associated therewith are/is located at the axial end of the transmission input shaft that supports one of the gear-step gearwheels of the highest even gear step. Preferably, the highest even gear step is the fourth gear step and/or the transmission input shaft is the first transmission input shaft.

Preferably, the highest odd gear step and/or one of the gear-step gears associated therewith are/is located at the axial end of the transmission input shaft that supports one of the gear-step gearwheels of the highest odd gear step. Preferably, the highest odd gear step is the fifth gear step and/or the transmission input shaft is the second transmission input shaft.

In a first example embodiment, in sum, the gear-step gearwheels of the highest gear steps can be located at the axial outer sides of the shafts, in particular of the transmission input shafts. If the transmission has five gear steps, the fourth gear step and the fifth gear step, i.e., the gearwheels thereof, are arranged axially externally and the other gear steps and the gearwheels of the other gear steps are arranged within these two gear steps, the fourth and fifth gear steps.

Preferably, the gear-step gears of the fourth gear step and of the second gear step can be arranged on the second transmission input shaft from the outer side of the hybrid transmission device toward the inner side.

Preferably, the gear-step gears of the fifth gear step, of the third gear step, and of the first gear step can be arranged on the first transmission input shaft from the outer side of the hybrid transmission device toward the inner side.

Preferably, the hybrid transmission device can include precisely one drive device. An arrangement of one or multiple drive device(s) that act(s) at a certain point of the hybrid transmission device also counts as a drive device. This means, for example, in an example embodiment of the drive device as an electric motor, that multiple small electric motors can also be considered to be one electric motor if the electric motors summarize torque at a single starting point.

Advantageously, the drive device can be associated with the second transmission input shaft. The gears implemented via the first transmission input shaft and the gears implemented via the second transmission input shaft form a sub-transmission in each case. It may therefore also be stated that a drive device is associated with the second sub-transmission. Preferably, the hybrid transmission device includes precisely two sub-transmissions.

Preferably, the drive device is also designed as a generator. The drive device is then designed both as a motor and as a generator.

Preferably, the drive device is connected to the highest gear step of the transmission. Alternatively, the drive device can be connected to the second-highest gear stage of the transmission. In other words, the drive device can be connected to the highest gear stage of the sub-transmission at which the drive device acts.

Preferably, the drive device is connected to an axially externally situated gear step, more precisely, to one of the gearwheels of the gear step, of the transmission.

At this point, it is to be pointed out that, in the present invention, a connection, coupling, or operative connection refers to any power flow-related connection, also across other components of the transmission. A connection, however, refers to the first connecting point for transmitting drive torque between the prime mover and the transmission. The drive device is therefore connected to a gear-step gearwheel and is “only” connected or coupled to the second transmission input shaft.

A connection to a gear step, i.e., one of the gear-step gearwheels of the gear step, can take place via a gearwheel. An additional intermediate gear may be necessary in order to bridge the center distance between the output shaft of the drive device and the transmission input shaft. Due to the connection of the drive device to a gear-step gearwheel, a further gear plane can be avoided, which would be present only for the connection of the drive device.

Advantageously, at least one of the axially external gear-step gears, which are arranged on the axis of the transmission input shafts, can be designed as a fixed gear. Preferably, both axially external gear-step gears can be designed as fixed gears. The drive device can therefore preferably be arranged in a P3 arrangement, i.e., at the transmission gear set.

Preferably, one drive device can be connected to the fifth gear stage.

Alternatively, a drive device can be connected to the fourth gear stage.

Preferably, the drive device can be utilized for an electric or fluidic forward starting operation. In this case, the second drive device can be coupled, advantageously, to the gear-step gears of the second gear step or the first gear step. The starting operation is always performed by the drive device in this case. The drive device can preferably be utilized as a sole drive source for the starting operation. Similarly, the drive device can be utilized for electric or fluidic travel in reverse. Preferably, it can also be provided here that the drive device is the sole drive source during travel in reverse. In this case, there are no internal-combustion-engine or hybrid reverse gears.

Preferably, the drive device can be arranged axially parallel to the first transmission input shaft. The drive device is then preferably also axially parallel to the second transmission input shaft and to the countershaft. In the present invention, an axially parallel arrangement refers not only to completely parallel arrangements. An inclination or an angle between the longitudinal axis of the transmission input shafts and the longitudinal axis of the electric motor can also be present. Preferably, an angle is provided between the longitudinal axis of an electric motor and the longitudinal axis of the transmission input shafts of less than or equal to ten degrees (10)°, further preferably less than five degrees (5°) and, in particular zero degrees (0°). Slight inclinations of the drive devices in comparison to the transmission can result for reasons related to installation space.

Preferably, the axis of the drive device—given an axially parallel arrangement—in the installation position can be situated above the axis of the transmission input shaft. The installation position is always referenced in the following. During installation, the hybrid transmission device can also be upside down. Such positions are irrelevant for the following description, however. While the axially parallel arrangement also makes it possible for the drive device to be located below the axis of the transmission input shaft, it is advantageously provided that the drive device and, thereby, the axis of the drive device, is positioned above the transmission input shaft. In this arrangement, the packing density can be maximized.

Preferably, the axis of the drive device in the installation position can be situated above the axes of one or multiple countershaft(s) and/or one or multiple output shaft(s). The drive device is therefore situated above the aforementioned components of the spur gear drive arrangement. Alternatively, it can therefore be said that the axis of the drive device in the installation position is the uppermost axis of the hybrid transmission device.

The drive device can be arranged in the axial direction preferably at the same level as the gear change transmission. Preferably, the overlap in the axial direction can be more than seventy-five percent (75%). Advantageously, the overlap is one hundred percent (100%). Here, the overlap is ascertained on the basis of the housing of the drive device. The output shaft of the drive device is not taken into account.

Advantageously, the drive device can be rotationally fixed to the second transmission input shaft. When the second transmission input shaft is arranged in such a way that the second transmission input shaft is connectable to the internal combustion engine by a clutch and, in particular, via the first transmission input shaft, the drive device can be utilized in many operating situations as a parallel drive source with respect to the internal combustion engine.

Alternatively, the drive device can be arranged coaxially to the axis of the transmission input shafts. Preferably, the drive device is then arranged axially between the connecting clutch and the first gearwheel on the second transmission input shaft. Preferably, the drive device in this example embodiment is connected to the second transmission input shaft.

Upon utilization of a separate gearwheel on one of the transmission input shafts for connecting the drive device, which is then not a gear-step gearwheel, the drive device can also be connected via a chain.

Advantageously, the first transmission input shaft can be directly connectable or connected to an internal combustion engine. Directly connected refers to a clutch-free connection. A damping device can be present, for example, between the crankshaft and the first transmission input shaft. The damping device can include a torsion damper and/or a damper and/or a slipping clutch. The torsion damper can be designed as a dual-mass flywheel. The damper can be designed as a rotational speed-adaptive damper.

Preferably, the first drive device and/or the second drive device can be designed as an electric motor. Electric motors are widespread in hybrid transmission devices.

Alternatively or additionally, the first drive device and/or the second drive device can be designed as a fluid power machine. In addition to electric motors, there are other prime movers, the utilization of which in hybrid transmission devices is conceivable. These can also be operated as motors, i.e., in a manner that consumes energy, or as generators, i.e., in a manner that converts energy. In the case of a fluid power machine, the energy accumulator is, for example, a pressure reservoir. The energy conversion then consists of converting the energy from the internal combustion engine into a pressure build-up.

Advantageously, the drive device can be power-shifted. A powershift is understood here, as usual, to mean that no interruption of tractive force occurs at the output of the hybrid transmission device during a gear change, for example, of the drive device. A reduction of the torque present at the output is possible, but a complete interruption is not. The support can take place via the internal combustion engine or an electric axle to be described more precisely below.

As a result, the motor vehicle can be continuously driven in large speed ranges, for example, exclusively electrically, wherein the ratio, i.e., the gear, is selected in each case so as to be optimized with respect to the rotational speed and torque of the drive device.

Advantageously, the drive device can be operatively connected to a differential via, at most, four meshing points. As a result, good efficiency is achieved.

The connecting clutch is utilized for coupling the sub-transmission. However, the connecting clutch is also a clutch for connecting the second transmission input shaft to the internal combustion engine, wherein the connection extends via the first transmission input shaft.

Preferably, the connecting clutch can be arranged at the end of the second transmission input shaft facing the outer side.

In the present invention, an engagement device is understood to be an arrangement with one or two shift element(s). The engagement device is designed to be one-sided or two-sided. A shift element can be a clutch or a gearshift clutch. A clutch is utilized for connecting two shafts in a rotationally fixed manner and a gearshift clutch is utilized for rotationally fixing a shaft to a hub rotatably mounted thereon, for example, an idler gear. The connecting clutch can be designed in the manner of a gearshift clutch and is referred to as a clutch simply because the connecting clutch connects two shafts to each other.

Preferably, one or more of the connecting clutch and/or gearshift clutches can be designed as dog clutches. In particular, the connecting clutch and all gearshift clutches can be designed as dog clutches.

Preferably, the first transmission input shaft in a first example embodiment is designed to be idler gear-free. Fixed gears, exclusively, can be arranged on the first transmission input shaft as gearwheels. In particular, precisely three fixed gears can be arranged on the first transmission input shaft.

Alternatively, at least one idler gear can be arranged on the first transmission input shaft. In particular, precisely one idler gear can be arranged on the first transmission input shaft. At least one engagement device can then be arranged on the first transmission input shaft. Preferably, at least two, in particular precisely two, engagement devices can be arranged on the first transmission input shaft. Preferably, both engagement devices can be designed to be one-sided. One engagement device is the connecting clutch and the second engagement device is the gearshift clutch at one end of the second transmission input shaft.

Advantageously, the second transmission input shaft can be designed to be engagement device-free and/or idler gear-free. Preferably, at least one fixed gear can be arranged on the second transmission input shaft. In particular, at least two, in particular precisely two, fixed gears can be arranged on the second transmission input shaft.

Advantageously, one fixed gear and one idler gear can be associated with each gear step and, in fact, a single fixed gear and a single idler gear in each case. In addition, each fixed gear and idler gear can always be unambiguously associated with a single gear step, i.e., there are no winding-path gears by utilizing one gearwheel for multiple gears. Nevertheless, the internal-combustion-engine gears one and three can be considered to be winding-path or coupling gears, since the first transmission input shaft is interconnected during the formation of the gears.

In one preferred example embodiment, the hybrid transmission device and/or the transmission can include precisely two two-sided engagement devices and two one-sided engagement devices for producing five internal-combustion-engine gears.

Preferably, a differential can be arranged in the axial direction at the level of a clutch for connecting the transmission input shafts. Advantageously, a gearwheel for connecting the differential can be arranged axially externally on a countershaft. The connection can preferably take place at the side of the internal combustion engine.

Preferably, the hybrid transmission device can include at least one, in particular precisely one, countershaft. In the case that a single countershaft is utilized, a single point of connection to the differential is present. As a result, installation space can be saved, which is the case in the radial direction as well as in the axial direction.

Preferably, at least one engagement device can be arranged on the countershaft. In a first alternative example embodiment, precisely two engagement devices, in particular two two-sided engagement devices, can be arranged on the countershaft. Preferably, precisely four idler gears and one fixed gear-step gear are then arranged on the countershaft. In a second alternative example embodiment, at least three engagement devices, in particular two two-sided engagement devices and one one-sided engagement device, can be arranged on the countershaft. In addition, advantageously, precisely five idler gears can be arranged on the countershaft.

Preferably, all shift elements of the engagement devices on the countershaft can be designed as gearshift clutches.

Preferably, a fixed gear for establishing a connection to the differential can be located on the countershaft.

Preferably, the two-sided engagement devices on the countershaft can enclose a one-sided engagement device in the axial direction. This means that one of the two-sided engagement devices is arranged ahead of and one of the two-sided engagement devices is arranged behind the one-sided engagement device or one is arranged to the right and one to the left of the one-sided engagement device.

In addition, the hybrid transmission device can include a control device. The control device is designed for controlling the transmission, by way of an open-loop system, as described.

In addition, the invention relates generally to a hybrid drive train including a hybrid transmission device and at least one electric axle, in particular a rear axle. The hybrid drive train is distinguished by the fact that the hybrid transmission device is designed as described. This configuration is preferably arranged with a single drive device in the hybrid transmission device. An electric axle is an axle having an electric motor associated therewith. The output of drive torque by the electric motor of the electric axle therefore first takes place in the power flow independently of the hybrid transmission device. Preferably, the electric axle is an assembly unit. The assembly unit can also include a separate transmission for multiplying the drive torque of the electric motor of the electric axle. This is preferably designed as a gear change transmission.

Upon utilization of an electric axle, the electric axle can support the drive torque when the drive device or the internal combustion engine changes the gear step. The hybrid transmission device is preferably associated with an axle other than the electric axle.

The invention also relates generally to a motor vehicle with an internal combustion engine and a hybrid transmission device or a hybrid drive train. The motor vehicle is distinguished by the fact that the hybrid transmission device or the hybrid drive train is designed as described.

Advantageously, the hybrid transmission device is arranged in the motor vehicle as a front-mounted transverse transmission device.

Preferably, the motor vehicle includes a control device for the open-loop control of the hybrid transmission device. The control device can therefore be part of the hybrid transmission device, although the control device does not need to be.

Preferably, a battery is arranged in the motor vehicle, which allows for an electric operation of the motor vehicle for at least fifteen (15) minutes. Alternatively, for a purely electric operation, the internal combustion engine, with one of the electric motors as a generator, can generate current, which goes directly to the other electric motor.

In addition, the motor vehicle can include a pressure reservoir. This can be utilized for operating a fluid power machine.

### BRIEF DESCRIPTION OF THE DRAWINGS

Further advantages, features, and details of the invention result from the following description of exemplary embodiments and figures, in which:

FIG. 1 shows a motor vehicle;

FIG. 2 shows a first example gear set scheme;

FIG. 3 shows a first gear shift matrix;

FIG. 4 shows a second gear shift matrix;

FIG. 5 shows a second example gear set scheme;

FIG. 6 shows a third example gear set scheme; and

FIG. 7 shows a fourth example gear set scheme.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

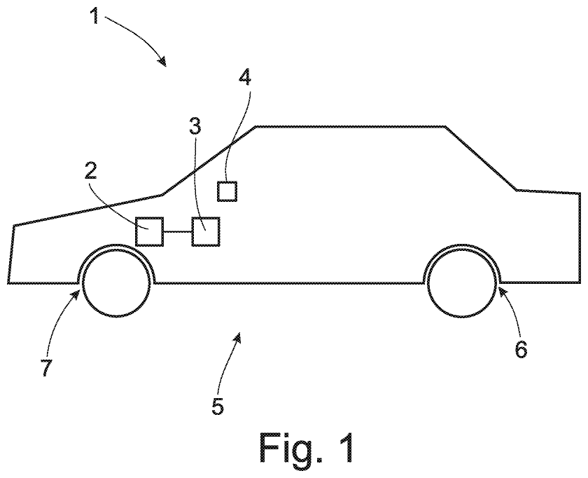

FIG. 1 shows a motor vehicle 1 with an internal combustion engine 2 and a hybrid transmission device 3. The hybrid transmission device 3 also includes, as described in greater detail further below, an electric motor, allowing the hybrid transmission device 3 to be installed as an assembly unit. This is not absolutely necessary, however. In principle, the hybrid transmission device 3 can also form an assembly unit without a previously connected electric motor. A control device 4 is provided for the open-loop control of the hybrid transmission device 3. The control device 4 can be part of the hybrid transmission device 3 or of the motor vehicle 1.

The hybrid drive train 5 can also include, in addition to the internal combustion engine 2 and the hybrid transmission device 3, at least one electric axle 6. The electric axle 6 is preferably the rear axle when the hybrid transmission device 3 is arranged as a front-mounted transverse transmission and drives the front axle 7, and vice versa.

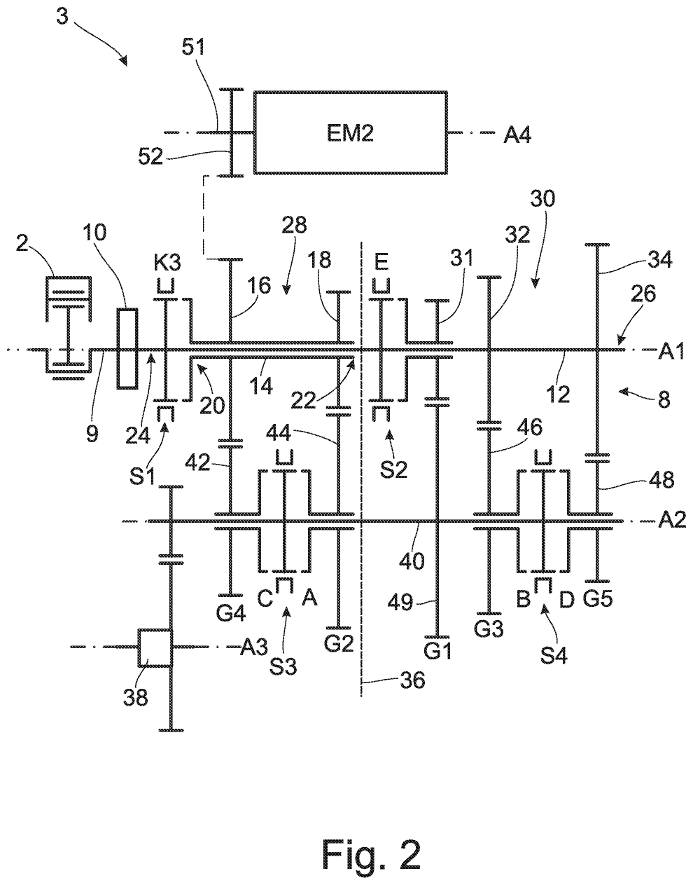

FIG. 2 shows the hybrid transmission device 3 and, in particular, the gear change transmission 8, in the form of a gear set scheme. In the following, the hybrid transmission device 3 will be described starting from the internal combustion engine 2. The crankshaft 9 is connected to the first transmission input shaft 12 via a damping device 10. The damping device 10 can include a torsion damper and/or a damper and/or a slipping clutch. A second transmission input shaft 14 is mounted on the first transmission input shaft 12. The connecting clutch K3 is provided in the engagement device S1 in order to connect the first transmission input shaft 12 to the second transmission input shaft 14. The connecting clutch K3 is arranged on the side of the internal combustion engine and axially externally on the first transmission input shaft 12.

Two fixed gears 16 and 18 are arranged on the second transmission input shaft 14. The fixed gear 16 is the fixed gear of the fourth gear step G4 and the fixed gear 18 is the fixed gear of the second gear step G2.

The second transmission input shaft 14 has two ends, namely one end 20 facing the outer side of the hybrid transmission device 3 and one end 22 facing the inner side of the hybrid transmission device 3. The first transmission input shaft 12 has an end 24 facing the engine 2 and an end 26 facing away from the engine 2, wherein reference is made here to the position in comparison to the internal combustion engine 2.

The clutch K3 can connect the sub-transmissions 28 and 30. A one-sided engagement device S2, the idler gear 31 associated with the engagement device S2, and the fixed gears 32 and 34, are also arranged on the first transmission input shaft 12. The engagement device S2 has a gearshift clutch E as the sole shift element. The idler gear 31 is the idler gear of the first gear step G1, the fixed gear 32 is the fixed gear of the third gear step G3, and the fixed gear 34 is the fixed gear of the fifth gear step G5. The gear-step gearwheels 16 and 34 of the highest gear steps G4 and G5 are located axially externally on the axis of the transmission input shafts A1. The gear steps G1, G2, and G3 are arranged axially internally, however.

The second transmission input shaft 14 is therefore designed to be shift element-free and idler gear-free. Precisely two one-sided engagement devices S1 and S2 are arranged on the first transmission input shaft 12. In the axial direction, the connecting clutch K3 is arranged at one end, namely the end 20 of the second transmission input shaft 14 facing the outer side of the hybrid transmission device 3, and the gearshift clutch E is arranged at the other end 22 of the second transmission input shaft 14. In addition, the gearshift clutch E, or the engagement device S2, is arranged on the axis A1 of the transmission input shafts 12 and 14.

The hybrid transmission device 3 includes a single countershaft 40 for connection to a differential 38 and for forming the gear stages or gear steps. Two engagement devices S3 and S4 with gearshift clutches A, B, C, and D are arranged on the countershaft 40 for connecting the idler gears 42, 44, 46, and 48 to the countershaft 40. The countershaft 40 also includes a fixed gear 49 of the first gear step G1. The fixed gear 49 is arranged in the middle of the idler gears 42, 44, 46, and 48. One fixed gear 50 for connecting the differential 38 is also provided on the countershaft 40. The fixed gear 50 is not associated with a single gear stage, however, and is therefore not a fixed gear-step gear. The assignment of the fixed gears and the idler gears to the gear steps results on the basis of the gear step numbers G1 through G5 below the gearwheels arranged on the countershaft 40.

On the basis of this scheme, the following can be determined with respect to the gear steps: one fixed gear and one idler gear are associated with each gear step G1 through G5 and, in fact, a single fixed gear and a single idler gear in each case; and each fixed gear and idler gear are always unambiguously associated with a single gear step, i.e., there are no winding-path gears by utilizing one gearwheel of multiple gear steps. Nevertheless, the gear steps G2 and G4 can be considered to be coupling gears, since the first transmission input shaft 12 is interconnected during the formation of the gear steps G2 and G4.

The electric motor EM2 is connected as shown and, in fact, at the axially external gearwheel 16. As a result, it is possible to connect the electric motor EM2 to the transmission input shaft 14 without an additional gearwheel, as the result of which installation space is saved. In particular, due to the connection of the electric motor EM2 at the axially external gearwheel 16, an axially extremely short hybrid transmission device 3 can be created.

The electric motor EM2 and/or the longitudinal axis of the electric motor EM2 is arranged in parallel to the transmission input shaft 12.

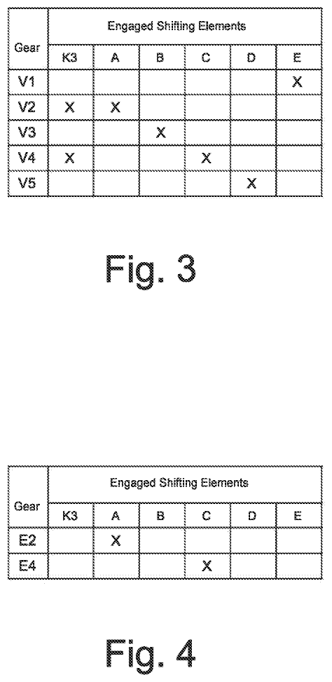

FIG. 3 shows a first gear shift matrix for the hybrid transmission device according to FIG. 2, in which it is apparent that five internal-combustion-engine gears V1 through V5 are implemented. In contrast to a typical dual-clutch transmission, in which clutches are alternately disengaged and engaged during the shifting of the forward gears, the even internal-combustion-engine gears V2 and V4 are implemented in that the clutch K3 is engaged and the odd internal-combustion-engine gears V1, V3, and V5 are implemented by disengaging the clutch K3. A changeover between the sub-transmissions 28 and 30 therefore preferably takes place by disengaging or engaging the clutch K3. In contrast to typical dual clutch transmissions, the utilization of the clutch is therefore implemented in a deviating manner. As is already also apparent from FIG. 2, precisely one of the gearshift clutches A through E is engaged and in the power flow in each of the internal-combustion-engine gears.

FIG. 4 shows a second gear shift matrix for the hybrid transmission device 3 according to FIG. 2, in which the electric gears E2 and E4 are indicated. The gear E2 is the first electric gear and the gear E4 is the second electric gear. The nomenclature results due to the association with the gear steps G1 through G5. The electric motor therefore exclusively utilizes the gear steps of the sub-transmission 28 having the even gears; all gear steps in this case, however. Only the second transmission input shaft 14 and the engagement device S3 with one of the gearshift clutches A or C are utilized.

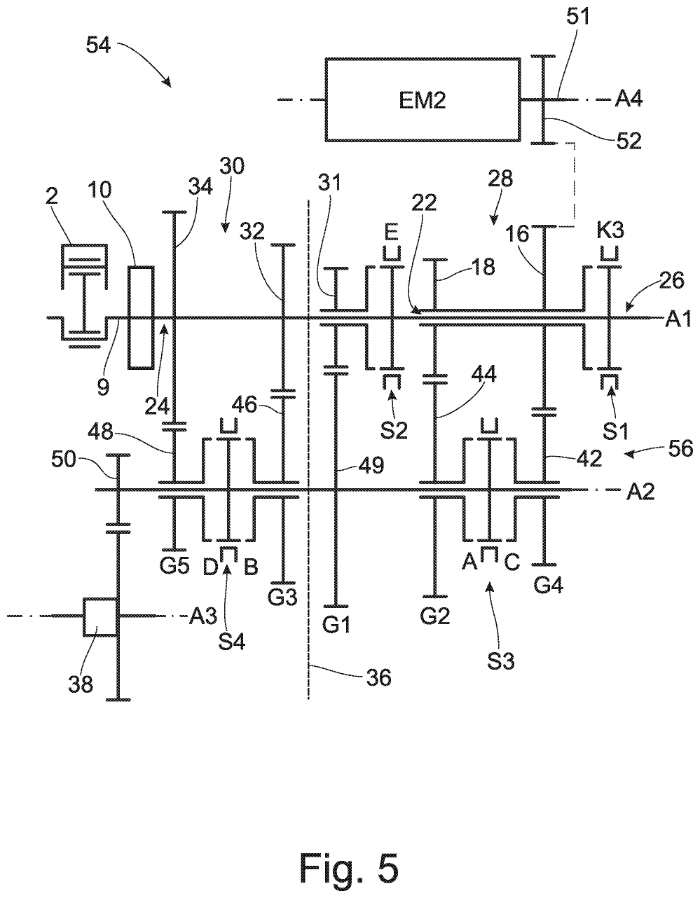

FIG. 5 shows a transmission device 56 similar to the hybrid transmission device 3 according to FIG. 2, wherein only the sub-transmissions 28 and 30 were mirrored along the axis of symmetry 36. The internal combustion engine 2, which does not belong to the gear change transmission 56, the damping device 10, and the gearwheel 50 for connecting the differential 38, as well as the differential 38, were not also mirrored. Identical reference characters label identical components, i.e., the fixed gear 16 is still the fixed gear of the fourth gear step G4. Reference is therefore made to FIG. 2 for the explanation of the gear change transmission 65 according to FIG. 5.

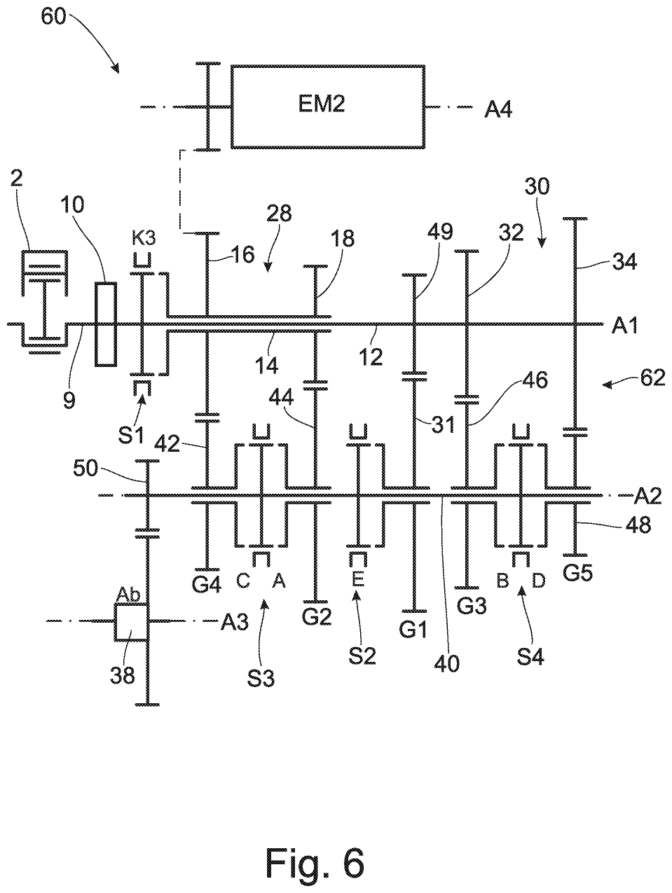

FIG. 6 shows a further modification of a hybrid transmission device 60, which differs from the hybrid transmission device 3 only with respect to the gear change transmission 62. In this case as well, identical reference characters indicate identical objects. Therefore, reference is largely made to FIG. 2 with respect to the description of the gear change transmission 62 and the hybrid transmission device 60. In contrast to the hybrid transmission device 3 according to FIG. 2, the idler gear 31, including the gearshift clutch E, has merely been moved from the first transmission input shaft 12 onto the countershaft 40. Therefore, the fixed gear 49 is mounted on the first transmission input shaft.

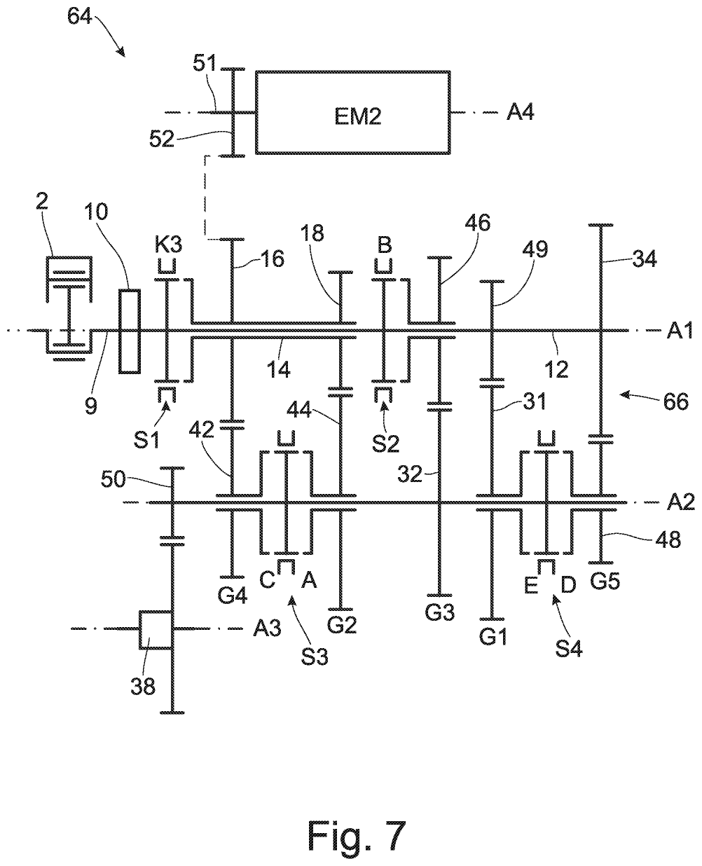

FIG. 7 shows a fourth embodiment of a hybrid transmission device 64 having a gear change transmission 66. Starting from the hybrid transmission device 3 according to FIG. 2, the gear steps G1 and G3 were interchanged, wherein a changeover of the idler gears and fixed gears also took place. The idler gear 46 of the third gear step G3 is therefore now arranged on the first transmission input shaft 12, which is why the gearshift clutch B also forms the engagement device S2. The fixed gear 32 of the third gear step is therefore arranged on the countershaft 40. The idler gear 31 of the first gear step G1, as well as the gearshift clutch E, were also moved onto the countershaft, while the fixed gear 49 of the first gear step G1 is situated on the transmission input shaft 12 in this case.

The gear shift matrices in FIGS. 3 and 4 therefore also apply in FIGS. 5 through 7.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 motor vehicle
2 internal combustion engine
3 hybrid transmission device
4 control device
5 hybrid drive train
6 electric axle
7 front axle
8 gear change transmission
9 crankshaft
10 damping device
12 first transmission input shaft
14 second transmission input shaft
16 fixed gear
18 fixed gear
20 end
22 end
24 end
26 end
28 sub-transmission
30 sub-transmission
32 fixed gear
34 fixed gear
36 axis of symmetry
38 differential
40 countershaft
42 idler gear
44 idler gear
46 idler gear
48 idler gear
50 fixed gear
51 output shaft
52 gearwheel
54 hybrid transmission device
56 gear change transmission
60 hybrid transmission device
62 gear change transmission
64 hybrid transmission device
66 gear change transmission
K3 clutch
S1 engagement device
S2 engagement device
S3 engagement device
S4 engagement device
A gearshift clutch
B gearshift clutch
C gearshift clutch
D gearshift clutch
E gearshift clutch
EM2 electric motor
A1 axis
A2 axis
A3 axis
A4 axis

1-15. (canceled)

16. A hybrid transmission device (3, 56, 60, 64), comprising:
a first transmission input shaft (12);
a second transmission input shaft (14) mounted on the first transmission input shaft, the second transmission input shaft (14) comprising an end (20) facing an outer side of the hybrid transmission device (3) and an end (22) facing an inner side of the hybrid transmission device (3);
at least one drive device (EM2);
at least one connecting clutch (K3) configured for selectively connecting the first and second transmission input shafts (12, 14); and
at least one gearshift clutch configured for selectively connecting an idler gear to one of the first and second transmission input shafts (12, 14),
wherein, in an axial direction, the connecting clutch (K3) is arranged at one end (20, 22) of the second transmission input shaft (14) and the gearshift clutch (B, E) is arranged at the other end (22, 20) of the second transmission input shaft (14).

17. The hybrid transmission device of claim 16, wherein the connecting clutch (K3) is arranged at the end (20) of the second transmission input shaft (14) facing the outer side.

18. The hybrid transmission device of claim 16, wherein the connecting clutch (K3) is arranged at the end of the second transmission input shaft (14) that face an internal combustion engine (2).

19. The hybrid transmission device of claim 16, wherein one or both of the connecting clutch (K3) and the gearshift clutch (B, E) is configured as a single shift element.

20. The hybrid transmission device of claim 16, wherein one or both of the connecting clutch (K3) and the gearshift clutch (A, B, C, D, E) is configured as a dog clutch.

21. The hybrid transmission device of claim 16, wherein precisely one of the at least one drive device (EM2) is associated exclusively with the second transmission input shaft (14).

22. The hybrid transmission device of claim 16, further comprising precisely two two-sided engagement devices (S3, S4) and precisely two one-sided engagement devices (S1, S2) configured for producing five internal-combustion-engine gears (V1, V2, V3, V4) and two electric gears (E1, E3).

23. The hybrid transmission device of claim 16, wherein the connecting clutch (K3) is mounted on the first transmission input shaft (12).

24. The hybrid transmission device of claim 16, wherein the gearshift clutch (B, E) is mounted on the first transmission input shaft (12) or on a countershaft (40).

25. The hybrid transmission device of claim 16, further comprising precisely one countershaft (40).

26. The hybrid transmission device of claim 25, wherein precisely two engagement devices (S2, S3) are arranged on the countershaft (40).

27. The hybrid transmission device of claim 25, further comprising a damping device (10), wherein the first transmission input shaft (12) is directly connected or connectable to a crankshaft (9) of an internal combustion engine (2) by the damping device (10).

28. The hybrid transmission device of claim 16, wherein the at least one drive device (EM2) is connected to a fixed gear (16).

29. The hybrid transmission device of claim 16, wherein at least one of two axially external gear-step gears (16, 34) arranged on an axis (A1) of the first and the second transmission input shafts (12, 14) is configured as a fixed gear.

30. A motor vehicle (1), comprising the hybrid transmission device of claim 16.
